(19) United States
(12) Patent Application Publication
(10) Pub. No.: US 2005/0104449 A1
(43) Pub. Date: May 19, 2005

(54) Mid-roller wheels for endless drive track system

(76) Inventors: Denys Lavoie, Sherbrooke (CA); Alain Lussier, St-Francois-Xavier-de-Brompton (CA)

Correspondence Address: FULBRIGHT & JAWORSKI L.L.P., 600 CONGRESS AVE., SUITE 2400, AUSTIN, TX, 78701, US

(21) Appl. No.: 10/717,416

(22) Filed: Nov. 19, 2003

(51) Int. Cl. B62D 55/00

(52) U.S. Cl. 305/136

(57) ABSTRACT

The mid-rollers of an endless track assembly of a track-type vehicle contacting the inner surface of the track as well as drive lugs formed thereon are formed of a solid heat-resisting thermoplastic material having low friction properties in at least areas of the rollers exposed to the drive lugs.

### FIELD OF THE INVENTION

The present invention pertains to the construction of mid-roller wheels which form part of the endless drive track system of track-type vehicles, such as agricultural, industrial or the like vehicle.

### BACKGROUND OF THE INVENTION

Track-type vehicles have track assembly that usually includes an endless rubber belt which wraps around a drive wheel, an idler wheel and a number of mid-rollers. The inner surface of the endless belt has a number of extending guide lugs which are guided through a channel formed by the wheel arrangement.

During use of the vehicle, the drive wheel rotates and engages the endless belt thereby causing the belt to rotate around the path defined by the drive wheel, idler wheel and mid-rollers. Rotation of the endless belt causes each of the guide lugs to pass through the channel defined by the drive wheel, idler wheel and each of the mid-rollers. Having the guide lugs passing through the guiding channel enables the belt to remain within the rolling path. The contact between the guide lugs passing through the drive wheel, idler and each of the mid-rollers is a source of wear for the components. Friction between guide lugs and mid-rollers are probably the worst source of wear because of the velocity difference between the guide lugs and the rotating mid-rollers. This friction generates heat which accelerates deterioration of guide lugs and mid-rollers, often resulting in guide lug chunking.

### STATEMENT OF THE INVENTION

In order to reduce friction between endless belt guide lugs and mid-rollers, the present invention is concerned with constructing mid-rollers with the low friction material. This is achieved by providing the rollers with a solid heat resisting thermoplastic material having low friction properties thereby replacing the conventional steel rubberized mid-rollers.

Therefore, an object of the present invention is to provide solid low friction material without rubber coating to replace the steel rubberized wheels.

The low friction material may be UHMW, polyurethane or any other such low friction material.

It is also an object of the invention to lower the contact point between the guide lugs and the mid-rollers thus reducing velocity difference and the risk of guide lug chunking. Also, by lowering the contact point, the guiding effect is increased.

In one formed of the invention, the design of the wheel is symmetric so both faces of the wheel can be used.

### BRIEF DESCRIPTION OF THE DRAWINGS

FIG. 1 is perspective view showing a pair of mid roller wheels in contact with the inner surface of a segment of an endless track;

FIG. 2 is an elevation end view of the arrangement shown in FIG. 1; and

FIG. 3 is an elevation side view of the arrangement shown in FIG. 1.

### DESCRIPTION OF PREFERRED EMBODIMENTS

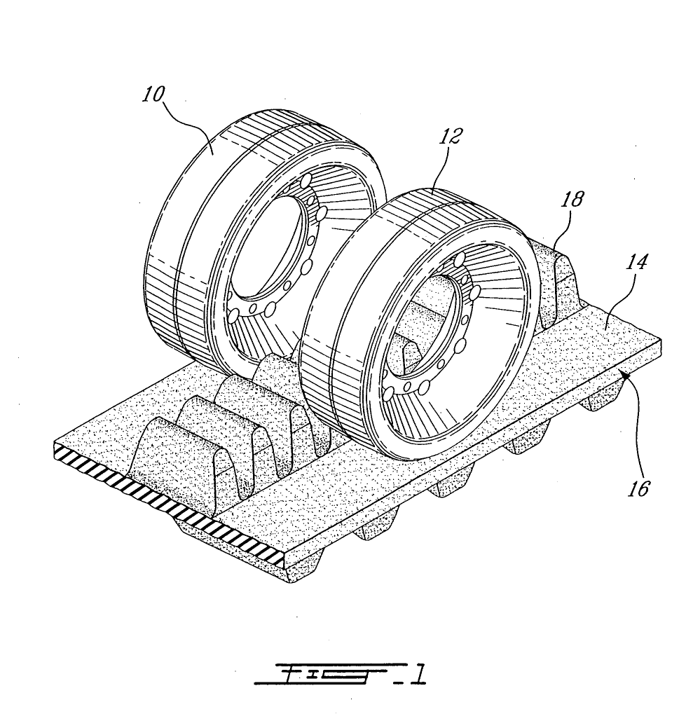

FIG. 1 shows a pair of mid-rollers 10 and 12 in contact with the inner surface 14 of an endless track 16. The inner surface of the track has a series of longitudinally spaced drive lugs 18 disposed centrally of the track. These drive lugs define a guiding path for the rotating track.

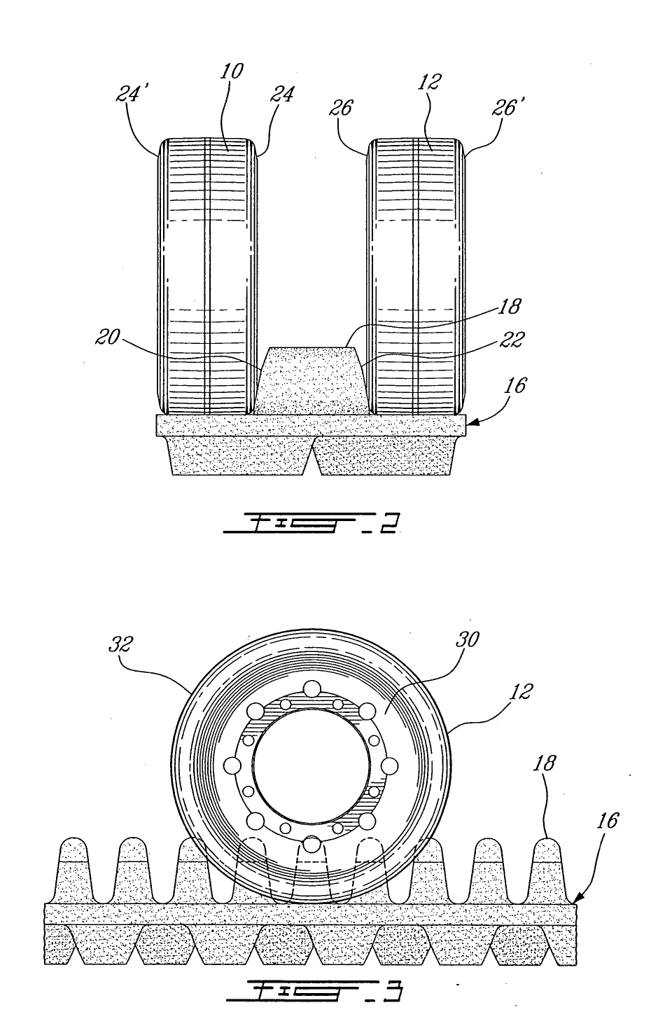

Referring to FIG. 2, each of the drive lugs 18 has a pair of opposite side faces 20 and 22 which are in contact with the inner circumferential edges 24 and 26 of the drive wheels 10 and 12.

Referring to FIG. 3, each mid-roller 12 includes an annular steel frame 30 which is adapted to be mounted to the drive track system. The annular steel member 30 is embedded in an annular band 32 made of a low friction material.

In a preferred form of the present invention, the construction of the mid-roller is symmetric so that, should the circumferential edges 24 and 26 be worn, the mid-rollers can be rotated so that their opposite peripheral edges 24′ and 26′ may now contact the side surfaces 20 and 22 of the lugs.

The low friction material which is considered for the mid-rollers is UHMW, polyurethane or any such low friction material.

Although the invention has been described above with respect to one specific form, it will be evident to a person skilled in the art that it may be modified and refined in various ways. It is therefore wished to have it understood that the present invention should not be limited in scope, except by the terms of the following claims.

1. In a track type vehicle having a track assembly including an endless rubber belt wrapped around a drive wheel, an idler wheel and a series of mid-rollers contacting the inner surface of the belt and drive lugs centrally mounted on said inner surface; each said mid-roller being formed of a solid heat resisting thermoplastic material having low friction properties in at least areas exposed to said drive lugs.

2. In a track type vehicle as defined in claim 1, wherein said mid-rollers have opposite side faces made of said thermoplastic material.

3. In a track type vehicle as defined in claim 1, wherein said material is UHMW.

4. In a track type vehicle as defined in claim 1, wherein said material is polyurethane.
